(19) United States
(12) Patent Application Publication
(10) Pub. No.: US 2024/0376915 A1
(43) Pub. Date: Nov. 14, 2024

(54) TOLERANCE COMPENSATING ELEMENT HAVING A DOUBLE THREADED BOLT, SCREW CONNECTION BETWEEN TWO COMPONENTS BY MEANS OF THE TOLERANCE COMPENSATING ELEMENT, AND METHOD FOR PRODUCING THE TOLERANCE COMPENSATING ELEMENT

(71) Applicant: Böllhoff Verbindungstechnik GmbH, Bielefeld (DE)

(72) Inventors: Sandra STEFFENFAUSEWEH, Verl (DE); Alexander VORDERWISCH, Bielefeld (DE)

(21) Appl. No.: 18/684,106

(22) PCT Filed: Jun. 29, 2022
(86) PCT No.: PCT/EP2022/067963

§ 371 Date: Feb. 15, 2024

(30) Foreign Application Priority Data
Aug. 17, 2021 (DE) 10 2021 121 385.1

(51) Int. Cl. F16B 5/02

(52) U.S. Cl. CPC F16B 5/0233

(57) ABSTRACT

A tolerance compensation element with which tolerances in the distance between a first and a second component are compensable, with the tolerance compensation element comprising: a double threaded bolt with a first and a second axial thread section with opposite convolution direction which are separated from one another by means of a supporting shoulder arranged between them, and adjacent to the first thread section, a tapered retaining section with a dragging element arranged on it is provided in a direction facing away from the shoulder, being adapted to co-rotate the tolerance compensation element via the dragging element in a friction-fit manner by means of an inner thread of a female thread element matching the first thread section.

### 1. FIELD OF THE INVENTION

The present invention relates to an automatic tolerance compensation element with which tolerances in the distance between a first and a second component can be compensated automatically, with the core of the tolerance compensation element consisting of a double threaded bolt with an intermediate supporting shoulder. Furthermore, the present invention relates to a screw connection between a first and a second component with the above-mentioned tolerance compensation element. Furthermore, the present invention comprises a manufacturing method for the tolerance compensation element.

### 2. BACKGROUND OF THE INVENTION

In the state of the art, a number of various constructions of tolerance compensation elements is known. Same can be divided into the group of automatic tolerance compensation elements and the group of non-automatic tolerance compensation elements. An automatic tolerance compensation element is capable of automatically compensating a present distance between the two components which are fastened at one another when screwing in the fastening screw into the tolerance compensation element. A non-automatic tolerance compensation element is fastened with the help of a fastening screw to the two components, too, the distance to be compensated by the tolerance compensation element between the two components does, however, need to be adjusted separately.

In the construction of different tolerance compensation elements, double threaded bolts are often used. A double threaded bolt is understood to be a bolt having two axial thread sections of different convolution directions separated by a supporting shoulder arranged in between. DE 10 2017 206 651 A1 discloses such a double threaded bolt, however, same is used for compensating lateral tolerances within a passage opening exceeding the outer diameter of the double threaded bolt.

DE 10 2016 209 395 A1 describes a fastening bolt having a supporting shoulder, from which supporting shoulder an axial thread section extends on one side, only. The opposite axial section is formed cylindrically so that a clamping bushing with thread is movably arranged on it and can be fastened. Thus, the second thread of the threaded bolt is provided by the clamping bushing. This construction, does, however, require that the distance between the two components is adjusted individually by the worker as the movable clamping bushing is not displaced by means of an automatic tolerance compensation.

US 2019/0128311 A1, U.S. Pat. No. 10,309,435 B2 as well as DE 10 2015 007 042 A1 each describe a double threaded bolt with a supporting shoulder. While the one thread section is screwed into a first component, the fastening to the first component is achieved by screwing a female thread element on the second axial thread section. The inner thread of the female thread element is characterized by the fact that a friction value between the inner thread of the female thread element and the second thread section is larger than a friction value between the first thread section and a receiving thread of the first component. This will lead to a rotation of the female thread element axially displacing the first thread section of the double threaded bolt in the first component until the supporting shoulder abuts the second component. The abutting of the supporting shoulder to the second component forms the basis for overcoming the moment of friction between the inner thread of the female thread element and the second thread section. An increased moment of friction or moment of resistance between the inner thread of the female thread element and the thread of the second thread section is for example generated by a specific thread error and/or a thread waviness or other constructional inhibitions between the engaging threads of the axial thread section and the female thread element.

DE 10 2017 131 235 A1 as well as DE 202 04 994 U1 also use a double threaded bolt with supporting shoulder. While in DE 202 04 994 U1, the first thread section is screwed into the inner thread of a blind rivet nut, the fastenings to the second thread section take place by means of an adjusting nut or a nut with a clamping insert. Such clamping inserts or friction elements within a female thread of a thread element do, however, have a relatively wide range of a moment of inhibition so that they are only adaptable to a connecting method with tolerance compensation with a high impreciseness.

It is therefore the object of the present invention to provide an alternative tolerance compensation element with automatic tolerance compensation between two components to be fastened to one another, which, based on an economic construction, guarantees that two components which are distanced from one another are reliably screwed together.

### 3. SUMMARY OF THE INVENTION

The above object is solved by an automatic tolerance compensation element, with which tolerances in the distance between a first and a second component are compensable, according to the independent claim 1. Furthermore, the above object is solved by a screw connection between a first and a second component with the help of the above-mentioned tolerance compensation element according to claim 7 as well as a manufacturing method for the tolerance compensation element according to the independent claim 9. Advantageous embodiments and further developments of the present invention arise from the following description, the accompanying drawings as well as the appending claims.

The inventive automatic tolerance compensation element with which tolerances in the distance between the first and the second component are compensable comprises the following features: a double threaded bolt with a first and a second axial thread section with opposite convolution direction which are separated from one another by means of a supporting shoulder arranged between them, preferably at least one drive means for rotating the threaded bolt is arranged adjacent to a first and/or a second axial end of the threaded bolt, and adjacent to the first thread section, a tapered retaining section with a dragging element arranged on it is provided in a direction facing away from the shoulder, with the retaining section being adapted to co-rotate the tolerance compensation element with dragging element or via the dragging element in a friction-fit and/or form-fit manner by means of an inner thread of a female thread element matching the first thread section, so that a distance between the first and the second component is automatically bridgeable by means of the tolerance compensation element.

Core piece of the inventively preferred tolerance compensation element is the double threaded bolt. Preferably, the double threaded bolt is configured as one part or integrally so as to guarantee the required stability of the tolerance compensation element. Two thread sections extend from a supporting shoulder of the double threaded bolt in the opposite direction, each thread section having one thread each, which when being compared with one another have an opposite convolution direction. The first thread section includes a retaining section having a dragging element arranged on it. Preferably, the retaining section has a tapered configuration in comparison to the first thread section. Therefore, arranging the dragging element on the retaining section is facilitated. It is also preferred that the dragging element is held on the retaining section independent of its configuration and choice of material in a friction-fit manner, firmly bonded or in a form-fit manner.

This dragging element provides a sufficiently high moment of friction between dragging element and double threaded bolt as well as between dragging element and female thread element as soon as a female thread element is intended to be screwed on the first thread section by means of this dragging element. This will in turn lead to a desired co-rotation of the double threaded bolt by means of the dragging element with the female thread element so that the rotation movement in combination with the second thread section causes a displacement of the supporting shoulder in the direction of a second component which is distanced to a first component, so as to compensate or bridge, respectively, the distance between the components.

It is also preferred that the dragging element be fastened form-fit and/or firmly bonded on the retaining section so as to transmit the rotation of the female thread element on the double threaded bolt. According to a further preferred configuration of the present invention, the female thread element establishes a form-fit and/or friction-fit connection with the radial outside of the dragging element so as to transmit a rotation.

Preferably, the dragging element is provided as a separate part compared to the double threaded bolt so that same can be plugged on the preferably tapered retaining section of the first thread section.

According to a preferred configuration of the double threaded bolt, at least one drive feature for rotating the threaded bolt is arranged adjacent to a first and/or a second axial end of the threaded bolt. The drive feature facilitates the connection between the double threaded bolt and a tool so as to transmit the rotation of the tool to the double threaded bolt.

It is also preferred to do without the drive feature. In this case, the worker preferably manually holds and screws in the double threaded bolt, without this process requiring a tool or constructive provisions for transmitting a rotation movement.

According to a preferred configuration of the present invention, the dragging element is a threaded sleeve with an outer thread consisting of metal or plastic material.

In the context of the preferred manufacturing of the automatic tolerance compensation element, the preferred threaded sleeve of the dragging element is plugged onto the retaining section. It is understood that an inner diameter of the threaded sleeve is configured such that a friction-fit connection between the threaded sleeve and the retaining section or the double-threaded bolt is strong enough to co-rotate the double-threaded bolt by means of the rotation of the dragging element. In order to realize same, different metals or plastic materials are used as they realize a sufficiently high friction value between the preferred tapered retaining section and the threaded sleeve. The same function is preferably also achievable by means of a form-fit connection between the retaining section and the radial inner side of the dragging element. For this purpose, square, hexagonal or generally polygonal profiles as well as torx profiles are preferably used.

Consequently, a geometric anti-rotation security or an anti-rotation security determined by the friction value is preferably used between dragging element and retaining section of the double-threaded bolt. Combinations of same are certainly also preferred.

According to a further preferred configuration of the inventive tolerance compensation element, the threaded sleeve comprises one of the following features or a combination of these features: an offset of the thread pitch in comparison with a first thread section, an only partly formed thread section and an outer surface of the threaded sleeve having an increased friction value.

The different preferred features which were mentioned above generate a preferred moment of resistance between the inner thread of the female thread element which is supposed to be screwed on the outer thread of the dragging element, as preferably, the inner thread of the female thread element is adapted to the outer thread of the first thread section. Accordingly, an offset of the thread pitch of the dragging element in comparison with the first thread section exacerbates a screwing-on of the female thread element as this offset of the thread pitch at the same time also means an offset of the thread pitch in comparison with the inner thread of the female thread element.

A preferred only partly formed thread or an only partly formed thread turn on the dragging element also causes a moment of resistance when screwing-on the female thread element on the dragging element. This moment of resistance is sufficiently big to transmit the rotation of the female thread element via the dragging element on the double threaded bolt. As the convolution direction of the female thread element is opposite to the convolution direction of the second axial thread section, the rotation transmitted by the dragging element on the double-threaded bolt leads to the second thread section being screwed out from a thread opening from the first component, with the thread opening being adapted to the second thread section.

If the dragging element is equipped with an outer surface having an increased friction value, this will also lead to a moment of resistance when screwing the female thread element on the dragging element. This moment of resistance similarly leads to the double-threaded bolt being co-rotated via the dragging element.

According to a further preferred configuration of the inventive tolerance compensation element, the dragging element is made of a plastic sleeve which is plugged on the tapered retaining section or glued to it or molded to it.

The advantage of the preferred plastic sleeve as the dragging element is that it can be produced with low effort and be plugged on the tapered retaining section of the first thread section. It is similarly preferred that the plastic sleeve be directly injected to the tapered retaining section. Such a plastic sleeve preferably provides a sufficiently high friction value at its radial inside as at its radial outside. The friction at the radial inside provides for the plastic sleeve and thus the dragging element to have a sufficiently strong retention on the tapered retaining section. The sufficiently high friction value at the radial outside preferably provides for the double threaded bolt to be co-rotated with the female thread element when the female thread element is screwed on the dragging element. Thus, the automatic tolerance compensation is guaranteed by the co-rotation of the double-threaded bolt with the female thread element even when using a plastic sleeve as the dragging element.

According to a further preferred configuration of the present invention, the plastic sleeve of the dragging element has a cylindrical or a conical outer shape.

In other words, the plastic sleeve of the dragging element is preferably configured conically or cylindrically in terms of its outer shape. While with regard to the preferred cylindrical design of the plastic sleeve, it is mainly the choice of material, namely the plastic material, which leads to the desired friction value, an increase or decrease of the diameter of the plastic sleeve leads to a changing moment of resistance between the female thread element and the dragging element when it comes to a conically shaped plastic sleeve. It is preferred that the conically shaped plastic sleeve is arranged on the tapered retaining section in a manner that the diameter of the plastic sleeve increases in the direction of the supporting shoulder. This has the preferred advantage that a lower diameter of the plastic sleeve supports screwing-on the female thread element. In turn, the increasing diameter of the plastic sleeve in the direction of the supporting shoulder increases the moment of resistance between female thread element and dragging element, which supports the co-rotation of the double-threaded bolt with the rotation of the female thread element.

According to a further preferred configuration of the tolerance compensation element, at least one drive feature for rotating the threaded bolt is arranged adjacent to a first and/or a second axial end of the threaded bolt, in particular a torx drive feature, a polygonal drive feature or a multi-tooth drive feature.

The present invention furthermore discloses a screw connection between a first and a second component in which the first component and the second component are fastened with each other at a distance to one another by means of the tolerance compensation element according to one of the previously described configurations, for the purpose of what the second axial thread section is screwed into a thread opening of the second component, the first component is supported by the supporting shoulder of the tolerance compensation element, facing away from the second thread section, the first axial thread section passes a fastening opening in the first component and the first component is held between the supporting shoulder and a female thread element that is screwed onto the first axial thread section.

According to a further preferred configuration of the screw connection according to the invention, the thread opening in the second component is formed by: a) a bayonet fastening with a thread bore arranged in a component opening, b) a blind rivet nut arranged in a component opening, c) an insert nut or a welding nut or d) a thread bore in the second component, directly.

According to different preferred configurations of the second component, the thread opening for screwing-in the second axial thread section is provided in different preferred ways. These constructions which may alternatively be used for fastening the second thread section are generally known in the state of the art. Preferably, a bayonet fastening is held in a threadless component opening. This bayonet fastening in turn comprises a thread opening having an inner thread matching the second axial thread section. Similarly, it is possible to fasten a blind rivet nut with inner thread in a component opening or to directly press an insert nut into the second component or to weld a welding nut to the second component. Finally, it is also preferred to equip a bore hole which is present in a second component with an inner thread adapted to the thread of the second axial thread section.

Furthermore, the present invention also discloses a manufacturing method for the tolerance compensation element according to one of the above-described preferred configurations. The manufacturing method includes the following steps: providing a double threaded bolt with a first and a second axial thread section of an opposite convolution direction which are separated from one another by means of a supporting shoulder arranged between them, wherein adjacent to the first thread section in a direction facing away from the shoulder, a preferably tapered retaining section and adjacent to at least one first or second axial end of the double threaded bolt, a drive feature for rotating the double threaded bolt is provided, arranging a dragging element on the retaining section consisting of a plastic sleeve or a metal sleeve which are held friction-fit or form-fit or firmly bonded on the tapered retaining section.

According to a further preferred configuration of the proper manufacturing method, the further step is provided: molding or plugging on the plastic sleeve of the dragging element which has a cylindrical or conical shape.

### 4. SHORT SUMMARY OF THE DRAWINGS

Subsequently, the present invention is described in detail with reference to the drawings. In this context, the same reference numerals in the figures refer to the same component and/or elements.

They show:

FIG. 1 a perspective lateral view of a preferred embodiment of the automatic tolerance compensation element with double threaded bolt and bayonet locking,

FIG. 2 the preferred embodiment of the tolerance compensation element according to FIG. 1 in a lateral partial sectional view,

FIG. 3 an explosion view of the tolerance compensation element according to the preferred embodiment in FIG. 1,

FIG. 4a-d an enlarged illustration of the double threaded bolt with the first thread section as well as a dragging element out of plastic material arranged on it, having a hollow-cylindrical like shape (a), an outer conical shape (b), a cylindrical shape with outer thread section (c) or a double-conical shape with an outer thread section,

FIG. 5 a lateral sectional view of the inventively preferred tolerance compensation element during the installation between two components,

FIG. 6 a lateral sectional view of the inventively preferred tolerance compensation element being installed between two components,

FIG. 7 a preferred embodiment of a keyhole in the second component for fastening the bayonet locking,

FIG. 8 a, b a lateral sectional view of a first (a) and a second preferred embodiment (b) of the double threaded bolt with supporting shoulder which is configured in different ways,

FIG. 9 a flow chart of a preferred embodiment of the manufacturing method of the inventively preferred tolerance compensation element.

### 5. DETAILED DESCRIPTION OF THE PREFERRED EMBODIMENTS

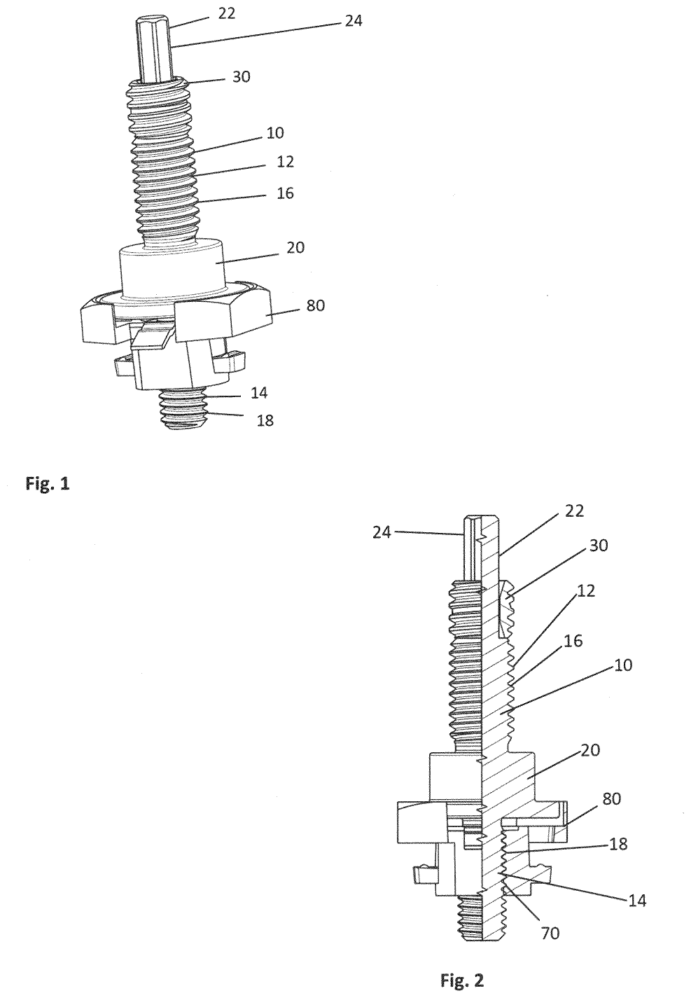

FIGS. 1 and 2 each show a perspective view of a preferred embodiment of the inventive automatic tolerance compensation element 1. While FIG. 1 shows the tolerance compensation element 1 in a lateral perspective view, FIG. 2 shows a partial section in longitudinal direction of the tolerance compensation element 1.

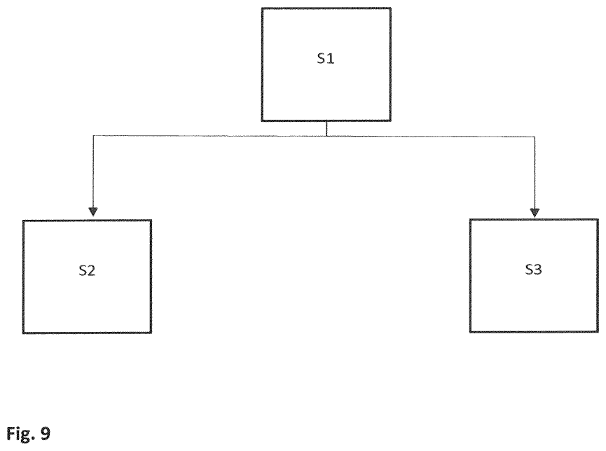

The tolerance compensation element 1 is made of a double threaded bolt 10 with a first axial thread section 12 and a second axial thread section 14. A supporting shoulder 20 is arranged between the first 12 and the second axial thread section 12, 14. According to different preferred configurations, the supporting shoulder 20 is built up in different ways (see below as well as FIG. 8).

The first axial thread section 12 and the second axial thread section 14 each include a thread 16, 18. The convolution direction of the threads 16, 18 is opposite in order to realize an automatic tolerance compensation of a distance between two components A, B while establishing a screw connection between the components A, B.

A tapered retaining section 22 is provided adjacent to the first thread section 12. A dragging element 30 is arranged on this tapered retaining section 22. It is also preferred that the retaining section 22 be provided non-tapered compared with the adjacent thread section 12. In this case, the retaining section 22 preferably includes an outer diameter corresponding to a core diameter of the thread section 12.

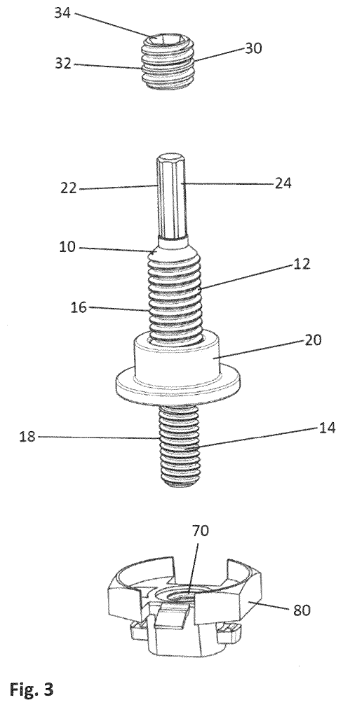

According to different preferred configurations of the present invention, the dragging element 30 is made of a metal sleeve as is shown in FIG. 3. The metal sleeve of the dragging element 30 comprises an outer thread 32. According to a preferred embodiment of the present invention, the outer thread 32 is configured with a pitch offset in comparison with the thread 16 of the first axial thread section 12. It is also preferred that the radially outwards extending thread convolution of the outer thread 32 of the dragging element 30 is provided over only a part of the axial length of the dragging element 30.

According to a further preferred configuration of the present invention, the radially outer surface of the dragging element 30 is provided with a surface roughness which generates a high moment of resistance or inhibition when screwing on a female thread element 60 onto the dragging element 30. The inhibition or moment of resistance is higher than a moment of inhibition when screwing in and/or screwing out the thread 18 of the second axial thread section 14 into/out from a thread opening 70 of the first component. Accordingly, when screwing-on the female thread element 60 on the dragging element 30, the double threaded bolt 10 is co-rotated with the dragging element 30 until the supporting shoulder 20 abuts the second component B by means of rotating-out the second axial thread section 14 from the thread opening 70 in the first component A. This rotating out is based on the convolution direction of the second thread 18 on the second axial thread section 14, the convolution direction being opposite to the first thread 16 on the first thread section 12.

As soon as the distance D (see FIG. 6) between the components is bridged by the tolerance compensation element 1, the female thread element 60 is screwed on the thread section 12 in the direction of the supporting shoulder 20. Screwing-on of the thread element 60 onto the thread section 12 ends as soon as the thread element 60 is in contact with the component B. Preferably, a specified tightening torque must be applied on the thread element 60 so as to achieve a reliable fastening, preferably a screwing on-block at the component B.

It is also preferred that inhibiting webs or inhibiting projections (not shown) are provided in the outer thread 32 of the dragging element 30 in order to generate or increase the inhibiting or moment of resistance.

It is furthermore preferred that the dragging element 30 in form of a metal sleeve is alternatively held in a friction-fit and/or form-fit manner on the tapered retaining section 22 (see FIG. 3). For the purpose of a form-fit connection, the retaining section 22 has a non-round outer contour 24, preferably a polygon, forming a torque-proof form-fit connection with a likewise non-round inner contour 34 of the dragging element 30. As an example, FIG. 3 shows a hexagonal contour 24 at the retaining section 22 engaging into a hexagonal opening 34 in the dragging element 30.

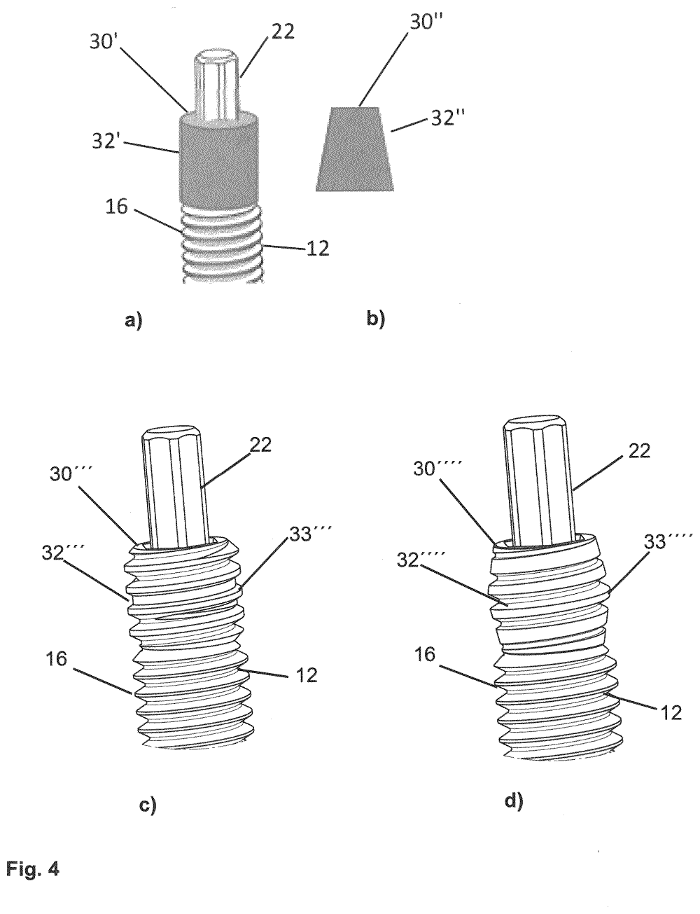

According to a further preferred embodiment, the dragging element 30′ is made of a plastic sleeve having a hollow cylindrical shape and corresponding lateral surfaces 32′ (see FIG. 4a). The dragging element 30′ is held on the retaining section 22 form-fit, friction-fit and/or firmly bonded. For this purpose the plastic sleeve 30′ is preferably prefabricated and then plugged onto the retaining section 22. It is also preferred that the plastic sleeve 30′ is directly molded to the retaining section 22, preferably injected with an injection molding method.

For a better retention between the dragging element 30′ and the retaining section 22, the dragging element 30′ is preferably glued together with the retaining section 22.

A further preferred embodiment of the dragging element 30″ comprises a plastic sleeve with a conical outer shape and the correspondingly shaped lateral surface 32″ (see FIG. 4 b). Thus, the dragging element 30″ includes a first axial end with a first outer diameter which is smaller than an outer diameter at a second axial end of the dragging element 30″.

The dragging element 30″ is preferably arranged on the tapered retaining section 22 in a way that the smaller outer diameter of the dragging element 30″ is positioned facing away from the axial thread section 12 and the larger outer diameter is positioned adjacent to the axial thread section 12. In this way, the smaller outer diameter supports screwing on the female thread element 60 on the dragging element 30″. During screwing on the female thread element 60 on the dragging element 30″, the larger outer diameter increases the moment of resistance between the dragging element 30″ and the female thread element 60 so that the double threaded bolt 10 is co-rotated with the dragging element 30″.

According to a further preferred configuration of the dragging element 30″, 30′″ out of plastic material, an outer thread is provided at the respective lateral surface 32′, 32″. This outer thread supports a connecting with the female thread element 60. Furthermore, the outer thread provides the preferred possibility of integrating moment of inhibitions constructively into the threaded connection between dragging element 30″; 30′″ and the female thread element 60. These constructive configurations have a similar shape as the constructions described above with regard to the dragging element 30. Correspondingly preferred embodiments are shown by FIGS. 4 c) and d).

In FIG. 4 c), the preferred dragging element 30′″ out of elastic plastic material has a hollow cylindrical shape. The radial outer lateral surface 32′″ comprises a threaded portion 33′″ which is configured similar as the thread section 12. If the threaded portion 33′″ does not transfer exactly into the thread section 12, the dragging element 30′″ is preferably radially displaceable on the retaining section 22. Thus, a screwing-on of the thread element 60 on the thread section 12 is guaranteed by the dragging element 30′″.

The preferred dragging element 30′″ in FIG. 4 c) preferably also consists of an elastic plastic material. The dragging element 30″″ preferably has the outer shape of a double conus with central passage opening. The axial ends of the dragging element 30″″ are tapered in comparison with an axial central portion of the dragging element 30″″ or are configured with a smaller outer diameter. The advantage of the double-conical shape is that when mounting the dragging element 30″″ on the retaining section 22, no alignment of the dragging element 30″″ needs to be observed.

It is likewise preferred that the double-conical dragging element 30″″ be provided as a simple conus with outer threaded portion. In this case, the dragging element 30″″ would only extend from an axial end up to its center.

In order to be able to screw the double threaded bolt 10 with the second axial thread section 14 into the thread opening 70 of the second component B, a drive feature is preferably provided adjacent to at least one axial end of the double threaded bolt 10.

It is also preferred to arrange a drive feature on both axial ends of the double threaded bolt 10.

According to different preferred configurations of the present invention, the drive feature is a torx, polygonal or multi-tooth drive feature. Such constructions are generally known in the state of the art.

As can be seen in FIGS. 1-4, the drive feature preferably consists of a non-round polygonal contour 24. At the same time, the drive feature 24 can also be used for holding the dragging element 30; 30′; 30″, 30′″, 30″″ in a rotation-proof, form-fit manner on the double threaded bolt 10.

Likewise, it is preferred that the double threaded bolt 10 is provided without drive feature. In this case, the tolerance compensation element 1 can be held in a friction fit manner manually or by means of a tool (not shown) and be rotated around its longitudinal axis. This will also guarantee a rotating-in of the double-threaded bolt into the first component A as well as a bridging of the distance D between the components A, B.

To establish a screw connection between the first component A and the second component B by bridging the intermediate distance D with the help of the tolerance compensation element 1, firstly, the second thread section 14 is screwed into the thread opening 70 of the first component A. This is preferably carried out by means of a tool (not shown) engaging at the drive feature 24.

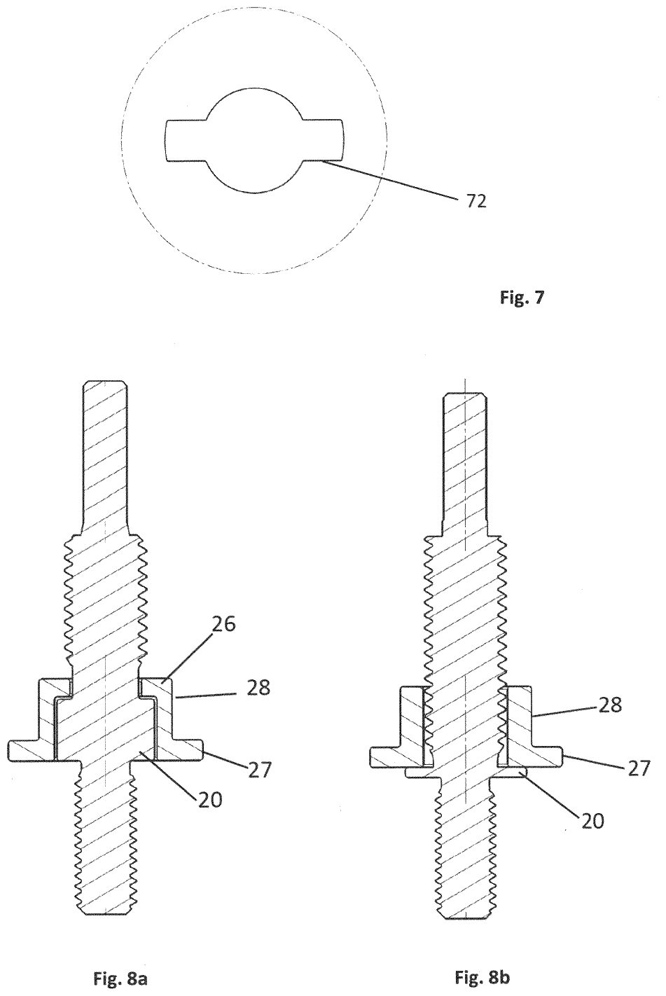

According to different preferred configurations, the thread opening 70 in the first component A is provided in a first component opening 72 as a blind rivet nut or insert nut or welded nut. According to another preferred embodiment of the present invention, the first component opening 72 is a keyhole (see FIG. 7) in order to receive and lock a bayonet fastening 80 with a thread opening.

The second thread 18 of the second thread section 14, preferably a left-hand thread, is first of all at least partly screwed into the thread opening 70 by means of a counterclockwise rotation.

Subsequently, the second component B is arranged opposite to the first component A in a way that the first thread section 12 passes through a second component opening 76. The second component opening 76 has an inner diameter which is smaller than an outer diameter of the supporting shoulder 20. It is furthermore preferred that the supporting shoulder 20 has a stepped configuration. A circumferential collar 27 of a larger diameter forms the supporting step for the second component B. A radially inwardly displaced shoulder section 28 guarantees a lateral tolerance compensation between the double threaded bolt 10 and the second component B as the shoulder section 28 is radially displaceable in there due to its smaller outer diameter compared with the second component opening 74. Furthermore, the supporting shoulder 20, 27, 28 preferably allows a metallic screwing on block of the component connection, even when the second component B is made of plastic material. In this way, positioning the second component B and releasing the component connection is avoided.

FIGS. 8 a, b show two preferred constructive alternatives to provide the supporting shoulder 20 with shoulder section 24. According to one configuration, the shoulder section 24 is configured sleeve-like (see FIG. 8 a). A radially inwardly protruding circumferential collar 26 is provided at its axial ends to be supported at the supporting shoulder 20 of the double threaded bolt 10. At the second axial end, a circumferential collar 22 protrudes radially outward, so as to be supported at the second component B.

According to a further preferred configuration, the supporting shoulder 20 is a circumferential collar protruding radially outward, which supports the shoulder section 28 that is configured like a double L in cross section. The supporting shoulder 20 is preferably elongated radially outwards by means of the circumferential collar 27 (see FIG. 8b).

With reference to FIGS. 8 a, b, it is also preferred that the shown at least two-part construction of the double threaded bolt 10 with supporting shoulder 20, 27, 28 be provided as an integral component, i.e. as one part.

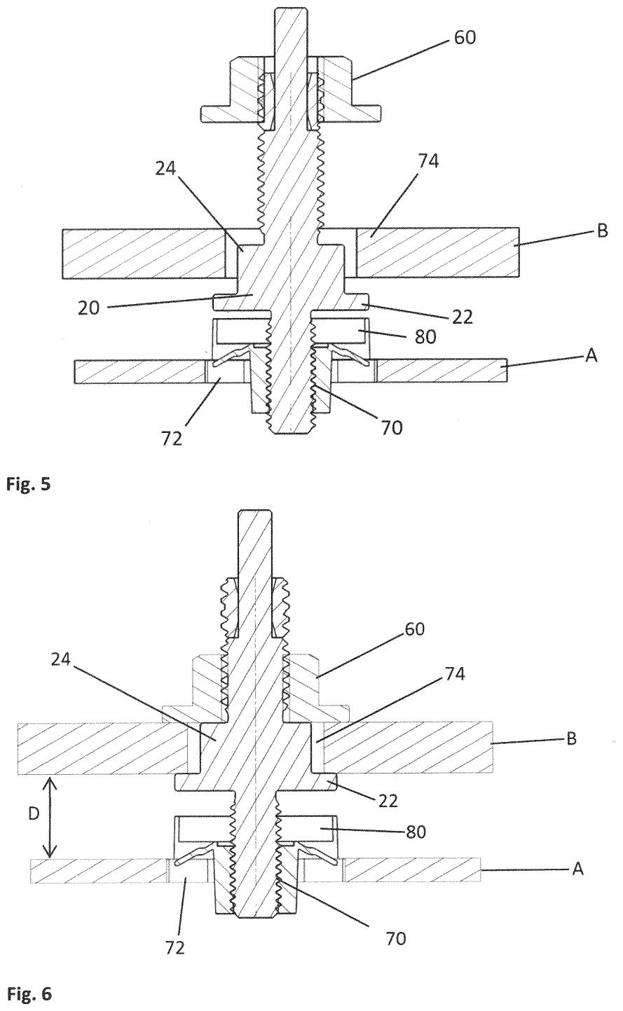

While the female thread element 60 is screwed on the dragging element 30; 30′; 30″ by a clockwise or counterclockwise rotation, the double threaded bolt 10 is preferably co-rotated by the friction-fit or firm bond between dragging element 30; 30′; 30″ and double threaded bolt 10. By co-rotating the double threaded bolt 10 clockwise or counterclockwise, the second thread section 14 is screwed out from the thread opening 70 until the supporting shoulder 20 abuts the second component B (see FIG. 5). By abutting the supporting shoulder 20 at the second component B, the further rotating overcomes the moment of inhibition between the female thread element 60 and the dragging element 30; 30′; 30″ and the female thread element 60 is screwed on the first thread section 12 (see FIG. 6).

For producing the automatic tolerance compensation element 1, firstly, the double threaded bolt 10 is provided (step S1). Depending on the application case of the automatic tolerance compensation element 1, it is preferred that the double threaded bolt 10 be made of plastic material or metal.

The dragging element 30; 30′; 30″ is then arranged adjacent to the first thread section 12 on the tapered retaining section 22 of the double threaded bolt 10. If the dragging element 30 according to a preferred embodiment of the invention is made of metal, it is plugged on the tapered retaining section 22. This approach is also preferred when the dragging element 30′; 30″ is provided as a plastic sleeve (see above). As the dragging element 30 out of metal or alternatively out of plastic material includes a central passage opening, the dragging element 30; 30′; 30″ is retained in a friction-fit manner on the tapered retaining section 22 after being plugged on it.

According to another preferred manufacturing alternative, the dragging element 30′; 30″ is molded to the tapered retaining section 22 (step S3). For this purpose, an injection molding method is preferably used according to a manufacturing method.

In case the double threaded bolt 10 is also made of plastic material, the double threaded bolt 10 and the dragging element 30′; 30″ are preferably made with a 2K (two components) injection molding method.

Finally, a bayonet locking with thread bore or a blind rivet nut is provided in order to fasten the double threaded bolt 10 in the first component A. For the fastening in the second component B, a nut 60 matching the first thread section 12 is provided.

### LIST OF REFERENCE SIGNS

1 automatic tolerance compensation element
10 double threaded bolt
12 first thread section of a first convolution direction
14 second thread section with a second convolution direction opposite to the first convolution direction
16, 18 thread of opposite convolution direction
20 supporting shoulder
22 retaining section
24 non-round outer contour
26 collar
27 collar
30; 30′; 30″; 30′″; 30″″ dragging element
32 outer thread of the dragging element
34 inner contour of the dragging element
60 female thread element
70 thread opening in the first component
72 first component opening
76 second component opening
80 bayonet fastening
A, B components
D distance between the components A, B

1. An tolerance compensation element with which tolerances in the distance between a first component and a second component are compensable, with the tolerance compensation element comprising:
a. a double threaded bolt with a first axial thread section and a second axial thread section with opposite convolution direction, which are separated from one another by means of a supporting shoulder arranged between the first axial thread section and the second axial thread section, and
b. adjacent to the first axial thread section, a retaining section with a dragging element arranged thereon is provided in a direction facing away from the supporting shoulder, the retaining section being adapted to co rotate the tolerance compensation element via the dragging element in a friction fit and/or form fit manner by means of an inner thread of a female thread element matching the first axial thread section, so that a distance between the first component and the second component is automatically bridgeable by means of the tolerance compensation element.

2. The tolerance compensation element according to claim 1, wherein the dragging element is a threaded sleeve with an outer thread comprising metal or plastic material.

3. The tolerance compensation element according to claim 2, wherein the threaded sleeve comprises one of the following features or a combination of these features: an offset of the thread pitch in comparison with the first axial thread section, an only partly formed thread section and an outer surface of the threaded sleeve having an increased friction value.

4. The tolerance compensation element according to claim 1, wherein the dragging element is a plastic sleeve which is plugged on the retaining section or is molded to the retaining section.

5. The tolerance compensation element according to claim 4, wherein the plastic sleeve of the dragging element has a cylindrical shape, or a double conical shape, or a conical shape.

6. The tolerance compensation element according to claim 1, wherein at least one drive feature for rotating the double threaded bolt is arranged adjacent to a first axial end and/or a second axial end of the double threaded bolt.

7. A screw connection between a first component and a second component in which:
the first component and the second component are fastened with each other at a distance to one another by means of the tolerance compensation element according to claim 1, wherein:
the second axial thread section is screwed into a thread opening of the second component,
the first component is supported by the supporting shoulder of the tolerance compensation element facing away from the second axial thread section,
the first axial thread section passes a fastening opening in the first component, and
the first component is held between the supporting shoulder and a female thread element that is screwed onto the first axial thread section.

8. The screw connection according to claim 7, where the thread opening in the second component is formed by: a) a bayonet fastening with a thread bore arranged in a component opening, b) a blind rivet nut arranged in a component opening, c) an insert nut or a welding nut, or d) a thread bore in the second component, directly.

9. A manufacturing method for a tolerance compensation element according to claim 1, the method:
a. providing a double threaded bolt with a first axial thread section and a second axial thread section of an opposite convolution direction, which are separated from one another by means of a supporting shoulder arranged between the first axial thread section and the second axial thread section, wherein adjacent to the first axial thread section, in a direction facing away from the supporting shoulder, a tapered retaining section is provided, and
b. arranging a dragging element on the retaining section, wherein the dragging element comprises a plastic sleeve or a metal sleeve, which are held friction fit or form fit or firmly bonded on the retaining section.

10. The manufacturing method according to claim 9 further comprising:
molding or plugging on the plastic sleeve of the dragging element, wherein the plastic sleeve has a cylindrical shape or a conical shape.
